(19) United States
(12) Patent Application Publication
(10) Pub. No.: US 2012/0081291 A1
(43) Pub. Date: Apr. 5, 2012

(54) GOLF STARTER ELECTRONIC TEE SHEET

(75) Inventor: Richard Anthony Meade, (US)

(73) Assignee: Jeffrey Scott Melcher, Washington, DC (US)

(21) Appl. No.: 13/251,999

(22) Filed: Oct. 3, 2011

Related U.S. Application Data
(60) Provisional application No. 61/389,325, filed on Oct. 4, 2010.

(51) Int. Cl. G06F 3/02; G06F 3/041

(52) U.S. Cl. 345/168; 345/173

(57) ABSTRACT

Provided is an electronic golf starter tee sheet that syncronizes with the golf pro shop computer system. Also provided is a method of using the electronic golf starter tee sheet.

This application claims domestic priority under 35 U.S.C. 120 to U.S. provisional patent app'n Ser. No. 61/389,325, filed 4 Oct. 2010, the complete disclosure of which is incorporated herein by reference.

### FIELD OF THE INVENTION

The invention relates to a golf starter electronic tee sheet that synchronizes with the golf pro shop computer system records. The invention also relates to a method of using the electronic tee sheet.

### BACKGROUND OF THE INVENTION

Golfers call the golf pro shop to schedule tee times. Golfers check in and pay for their tee time in the golf pro shop. Thus, the records in the golf pro shop change throughout the day.

Golf starters have paper tee sheets printed out first thing in the morning from the golf pro shop computer. Because of the various changes and updates that transpire in the scheduling, by the mid-day, the original paper tee sheet will look completely different than it did in the morning. The paper tee sheets are cumbersome. Changes and updates in scheduling are difficult to absorb and burden the efficiency of the starter, who is often running blind, and the golf course.

There is a great need for a golf starter tee sheet that syncronizes with the pro shop computer records.

### SUMMARY OF THE INVENTION

An objective of the invention is to provide an electronic tee sheet that synchronizes with the pro shop computer records.

This objective and other objectives are obtained by an electronic golf starter tee sheet comprising:
a touch screen sized so that at least one foursome of players names can be displayed at the same time;
a processor connected to the touch screen;
a wireless transceiver connected to the processor;
memory connected to the processor; and
software present in the memory configured for displaying a plurality of time slots on the touch screen, each time slot having at least four fields in which four golfer's names can be entered, a field for identifying whether each golfer paid, and syncronizing the electronic tee sheet information with information present on the golf pro shop computer system via the wireless transceiver.

The objectives are also obtained by a method of using an electronic golf course electronic tee sheet comprising:
a touch screen sized so that at least one foursome of players names can be displayed at the same time;
a processor connected to the touch screen;
a wireless transceiver connected to the processor;
memory connected to the processor; and
software present in the memory configured for displaying a plurality of time slots on the touch screen, each time slot having four fields in which four golfer's names can be entered, a field for identifying whether each golfer paid, a field for identifying whether each golfer has checked in on a pro shop computer system, and syncronizing the electronic tee sheet information with information present on the pro shop computer system, the method comprising:
synchronizing the electronic tee sheet with the pro shop computer over a wireless connection so that the electronic tee sheet displays the time slots with all of the golfers that have checked in with the pro shop.

### BRIEF DESCRIPTION OF THE DRAWINGS

FIG. 1 illustrates an electronic tee sheet;

FIG. 2 illustrates the electronic tee sheet of FIG. 1 updated with waiters; and

FIG. 3 illustrates the electronic tee sheet wirelessly connected to a golf pro shop computer system.

### DETAILED DESCRIPTION OF PREFERRED EMBODIMENTS

The electronic tee sheet is an electronic device which will help golf courses succeed in becoming increasingly more efficient. The preferred device is an iPad, and wirelessly connects to the pro shop computer system, such as by wifi. The electronic tee sheet has at least three functions that will improve efficiency at any golf course: up to date tee times, live check-in, and tee spot auto-fill. The electronic tee sheet can also identify whether the fees have been paid for walking, taking a cart, using a caddie, or using a push cart. Starters will enjoy the electronic tee sheet since it will simplify their jobs and make golf courses more efficient on the whole.

The up to date tee time will help keep starters informed though out the day. The electronic tee sheet preferably continuously synchronizes with the pro shop computer. However, if desired, the electronic tee sheet can be made to synchronize with the pro shop computer at defined intervals or when the pro shop or starter desires an update. After every sale, the pro shop computers preferably syncronize with the electronic tee sheet in order to maintain uniformity in scheduling. This mechanism will work preferably via wifi, but other wireless systems can be used, which the device can utilize in order to syncronize with the pro shop computer network. As a result, starters will automatically know of any cancelations or additions with respect to tee times. As it stands now, starters have paper tee sheets printed out first thing in the morning. Because of the various changes and updates that transpire in the scheduling, by the mid-day, the original paper tee sheet will look completely different than it did in the morning. The paper tee sheets are cumbersome—changes and updates in scheduling are difficult to absorb and burden the efficiency of the starter (who is often running blind) and the golf course. In contrast, the electronic tee sheet will allow starters to see the changes throughout the day. All changes during the day will appear on their device in real-time as the clubhouse computers sync following every sale meaning that starters will never be surprised by a change in the schedule.

In addition, the live check-in feature will show who actually shows up for their tee time, and, once there, whether or not they have paid. As it stands now, when a customer pays in the pro-shop or clubhouse, a symbol appears next to their name indicating proof of purchase, but this information is not relayed to the starter. However, with the tee sheet's synchronization capabilities, the pro-shop's salespeople and starters will both simultaneously know that a customer has paid. This will help resolve confusion by simply showing who is present and who is not. Most golf courses today print receipts for starters which customers are supposed to produce for the starters for proof of purchase purposes. Of course, people are liable to lose paper receipts, creating confusion and inefficiency. This becomes hectic for starters since they are often running on a tight schedule. On the other hand, the electronic tee sheet will render paper receipts obsolete, thereby improving efficiency and eliminating much of the confusion that burdens otherwise well run golf courses every day. By now knowing who's not there starters may fill in empty spots.

As golf grows in popularity, more and more people now show up to golf courses hoping to walk on. Oftentimes, customers will simply go to the starter to check for openings rather than checking at the proshop where the schedule is the most up to date. With, with the electronic tee sheet the starter will have information as up to date as that of the pro-shop and will be able to fill in gaps.

In practice, the starter can operate the device by holding their finger on the tee sheet's open slot. Having done so, a touch screen keyboard will pop up allowing the customer's name to be typed in. Alternatively, the pro shop can enter the customer's name and it will be updated to the electronic tee sheet. This helps the employees stay on top of any waiters.

Today, on packed days, people view the way the starters handle walk-ons as unprofessional. If a customer asks, the starter most times will write their name down somewhere on the paper. Then the customer has to enter the pro shop and, reenter their information for that time slot. Under this system, either the starter or the customer is liable to make a mistake, which results in an overbooking that invariably angers the customer, regardless of whose fault it is. The electronic tee sheet will prevent double bookings and make the customer feel valued. After entering the correct information with the starter, the customer can approach the counter where he or she can continue giving a warm feeling by having it on their computer. This will help retain customers by showing good transition.

Successful companies know that one bad experience with a customer can sully an otherwise sterling reputation and cost the company countless customers. By keeping up to date with technology, golf course who employ this device will help terminate bad reputations and provide customers with the kind of service that is so essential to staying profitable.

The invention will be described with reference to the attached Figs. As shown in FIG.

3, the electronic tee sheet 2 must have a touch screen 4 large enough for the starter to see at least one foursome (four golfers) of customers' names. An example of such a size is at least 2 inches high by 3 inches wide, preferably at least 4 inches high by 8 inches wide. The size should not be so large that it cannot be carried by the starter. The electronic tee sheet 2 must also have a processor and memory associated with the processor. Preferably, the electronic tee sheet 2 is a tablet device such as the Apple I-pad or copy thereof, such as the I-touch, HP Slate, Dell Tablet, We Pad, Google Chromium Tablet, Notion Ink Adam, Archos 7, Horne Tablet, Tablet, ICD Gemini, Jensen NVX3000PC, or JooJoo. Other examples include phones having a touch screen, such as Droid, Instinct, or I-phone.

The electronic tee sheet must also have a wireless connection 10 capability with the pro shop computer system 20, such as wifi. The pro shop computer system 20 generally includes a CPU 22, connected to a display 24, a keyboard 26 and a mouse 28.

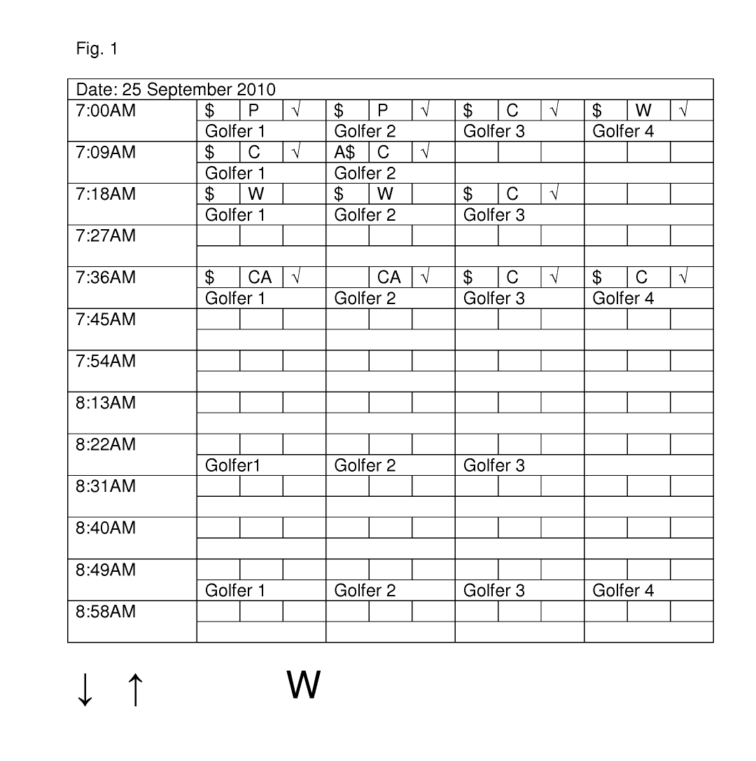

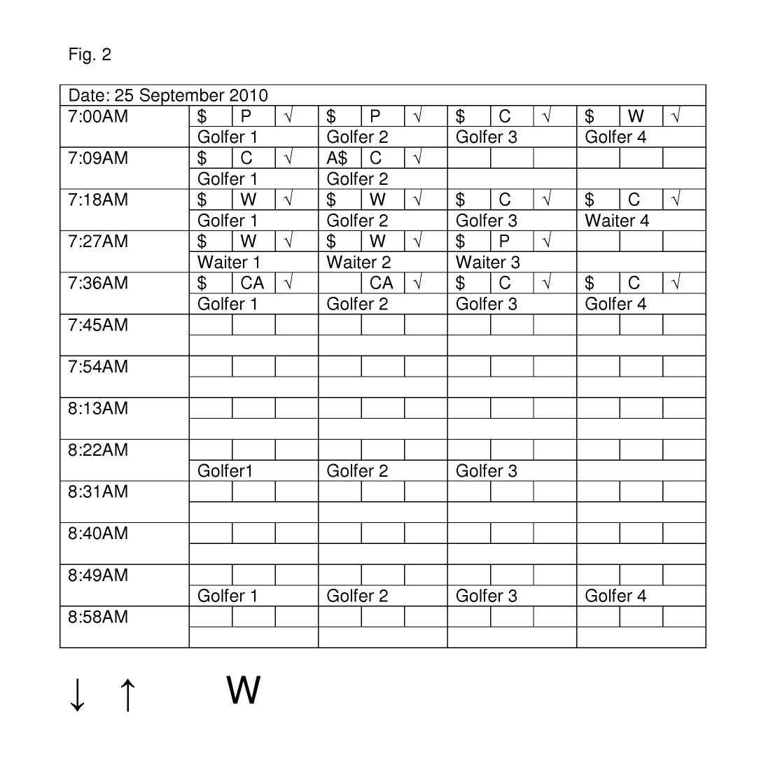

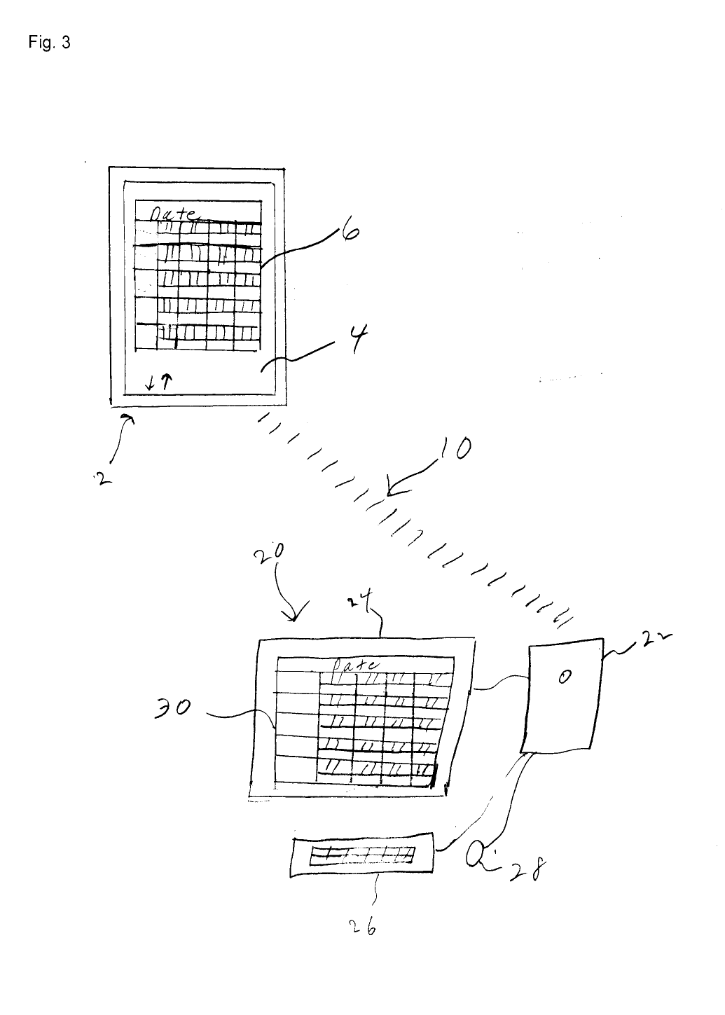

The software programmed on the electronic tee sheet 2 will allow for electronic tee sheet 2 to be paperless and update when the electronic tee sheet 2 syncronizes with the pro shop computer system 20. The electronic tee sheet 2 generally displays at least the same information generally present on paper tee sheets, shown at 6. The software should provide fields for the golfer's names, and associated fields for who has paid (shown by a $ in FIGS. 1 and 2) and checked in at the pro shop (shown by a check mark in FIGS. 1 and 2), what spots are still open and available (shown by open spaces in the name fields in FIGS. 1 and 2). Similar fields are provided by the pro shop software present in the golf shop memory and processor 22. When the electronic tee sheet 2 syncronizes with the pro shop computer system 20, the information shown at 6 is generally the same as shown at 30 in FIG. 3.

The electronic tee sheet 2 has many advantages over paper sheets. The golf starter can enter new golfer information into the touch screen 4, such as name (i.e. waiter 1), whether they are using a cart (C), walking (W), caddie (CA) or pull cart (P), and also whether the golfer paid ($), which will be wirelessly sent to the pro shop computer system 20. Similarly, any new golfer information in the pro shop computer system 20 will be sent to the electronic tee sheet 2. Thus, the golf course now only needs one employee with this system to open the course early in the morning, which will usually be the starter that can now perform all of the functions of both the starter and pro shop.

The present invention also ensures that there are double bookings; less confusion on check in, better efficiency; tee sheets can be current at all times; and it will be less likely that customers will have to wait in line.

A non-limiting example of how the electronic tee sheet works will now be provided.

An electronic display of the electronic tee sheet 2 information is shown in FIGS. 1-3 that stays up to date by wirelessly connecting to golf shop's computer system 20. When a customer checks in a check mark will appear in the corner of the box next to their name to confirm they are present at the golf course and $ sign will appear above their name to show they have paid. Optionally, one of the following symbols will be by the golfer's name representing: C (cart), W (walking), P (push cart) or CA (caddie). When the starter needs to edit a slot, a keyboard will appear on the screen when the slot is touched. Optionally, an icon (W) is at the bottom where an organized list will appear for waiters that can easily transfer names into open slots when available, as shown in FIG. 2.

While the claimed invention has been described in detail and with reference to specific embodiments thereof, it will be apparent to one of ordinary skill in the art that various changes and modifications can be made to the claimed invention without departing from the spirit and scope thereof.

I claim:

1. An electronic golf starter tee sheet comprising:
a touch screen sized so that at least one foursome of players names can be displayed at the same time;
a processor connected to the touch screen;
a wireless transceiver connected to the processor;
memory connected to the processor; and
software present in the memory configured for displaying a plurality of time slots on the touch screen, each time slot having at least four fields in which four golfer's names can be entered, a field for identifying whether each golfer paid, and syncronizing the electronic tee sheet information with information present on the golf pro shop computer system via the wireless transceiver.

2. The electronic golf course electronic tee sheet according to claim 1, the software further configured to provide a field on the touch screen to identify whether the golfer has paid for a golf cart, a caddie, or a push chart.

3. The electronic golf course electronic tee sheet according to claim 1, wherein the electronic tee sheet comprises a tablet device.

4. The electronic golf course electronic tee sheet according to claim 3, wherein the table is an I-Pad.

5. The electronic golf course electronic tee sheet according to claim 3, wherein the table is one selected from the group consisting of I-touch, HP Slate, Dell Tablet, We Pad, Google Chromium Tablet, Notion Ink Adam, Archos 7, Horne Tablet, Tablet, ICD Gemini, Jensen NVX3000PC, and JooJoo.

6. The electronic golf course electronic tee sheet according to claim 3, the software further configured to provide a field on the touch screen to identify whether the golfer has paid for the golf round.

7. A method of using an electronic golf course electronic tee sheet comprising:
a touch screen sized so that at least one foursome of players names can be displayed at the same time;
a processor connected to the touch screen;
a wireless transceiver connected to the processor;
memory connected to the processor; and
software present in the memory configured for displaying a plurality of time slots on the touch screen, each time slot having four fields in which four golfer's names can be entered, a field for identifying whether each golfer paid, a field for identifying whether each golfer has checked in on a pro shop computer system, and syncronizing the electronic tee sheet information with information present on the pro shop computer system, the method comprising:
synchronizing the electronic tee sheet with the pro shop computer over a wireless connection so that the electronic tee sheet displays the time slots with all of the golfers that have checked in with the pro shop.

8. The method of using an electronic golf course electronic tee sheet according to claim 7, further comprising synchronizing the electronic tee sheet with the pro shop throughout a day.

9. The method of using an electronic golf course tee sheet according to claim 7, further comprising adding a new golfer's name to a time slot in the electronic tee sheet using the touch screen, and the synchronizing the electronic tee sheet with the golf shop computer so that the new golfer's name appears in the same time slot on the pro shop computer.

10. A method of using an electronic golf course tee sheet comprising:
a hand held tablet comprising:
a touch screen sized so that at least one foursome of players names can be displayed at the same time on the touch screen;
a processor connected to the touch screen;
a wireless transceiver connected to the processor;
tablet memory connected to the processor; and
tablet software present in the memory; and
a pro shop computer system comprising:
a processor;
pro shop memory connected to the processor;
a display connected to the processor;
a keyboard connected to the processor; and
pro shop software present in the pro shop memory, wherein the tablet software and pro shop software are each configured for displaying a plurality of time slots on the touch screen and the display, each time slot having four fields in which four golfer's names can be entered, a field for identifying whether each golfer paid, a field for identifying whether each golfer has checked in on the pro shop computer system, and syncronizing the electronic tee sheet information with information present on the pro shop computer system, the method comprising:
a golf starter entering golfer information into the tablet using the touch screen;
a pro shop employee entering golfer information into the pro shop computer system; and
synchronizing the electronic tee sheet with the pro shop computer system over a wireless connection so that the electronic tee sheet displays the time slots with all of the golfers that have checked in with the pro shop and the golf shop computer system displays the golfer information entered by the starter into the tablet.

11. The method of using an electronic golf course electronic tee sheet according to claim 10, wherein the starter performs the functions of the pro shop and starter simultaneously by entering new golfer information and collecting golf fees, including entering the golfer's name.
